(19) United States
(12) Patent Application Publication
(10) Pub. No.: US 2014/0166372 A1
(43) Pub. Date: Jun. 19, 2014

(54) FLUID INTAKE MEASURING SYSTEM FOR INFANTS

(71) Applicants: Annie Elizabeth Sargood, Brighton (AU); Randall Laurence Cooke, Brighton (AU)

(72) Inventors: Annie Elizabeth Sargood, Brighton (AU); Randall Laurence Cooke, Brighton (AU)

(21) Appl. No.: 14/116,925

(22) PCT Filed: May 1, 2012
(86) PCT No.: PCT/AU2012/000461

§ 371 Date: Mar. 6, 2014

(30) Foreign Application Priority Data
May 11, 2011 (AU) 2011901780
Feb. 21, 2012 (AU) 2012900653

(51) Int. Cl. G01G 19/44

(52) U.S. Cl. CPC G01G 19/445
USPC 177/45; 177/127

(57) ABSTRACT

A fluid intake measuring system for an infant comprises a change mat containing or carrying a weighing pad responsive to the weight of an infant placed on the change mat, and a display responsive to the weighing pad to indicate weight gain or fluid volume intake of an infant placed on the mat prior to and following feeding. In an embodiment the system is integrated into a carrying bag. The mat when folded into a storage condition lies against an outer side of the bag, and in its unfolded operative state extends outwardly from a lower part of the side of the bag.

The present invention relates to a system for determining intake of fluid, such as breast milk or milk formula, or food by an infant. The present invention in its preferred embodiments relates to a weighing system associated with a baby change mat for determining the amount of milk, liquid or food consumed by the infant in a feeding session and may also be used for determining the amount lost by vomiting and urine output.

According to the invention, there is provided a fluid intake measuring system for an infant comprising a change mat for an infant, the mat containing or carrying a weighing pad responsive to the weight of an infant placed on the change mat, and a display responsive to the weighing pad to indicate weight gain or fluid volume intake of an infant placed on the mat prior to and following feeding.

In one embodiment, the weighing pad is a thin foldable pad having a filling of liquid (such as water), gas (such as air) or gel, and weight measurement is effected by sensing the pressure of the filling under the effect of the weight of the infant. The change mat is likewise foldable into a small volume whereby the overall system is easily storable and transportable.

In another embodiment the mat contains a series of two or more electronic weighing pads arranged in the length direction of the mat and interconnected whereby the display is responsive to the cumulative weight sensed by the series of an infant placed on the mat.

Preferred embodiments of the invention will now be described in greater detail by way of example only with reference to the accompanying drawings in which:

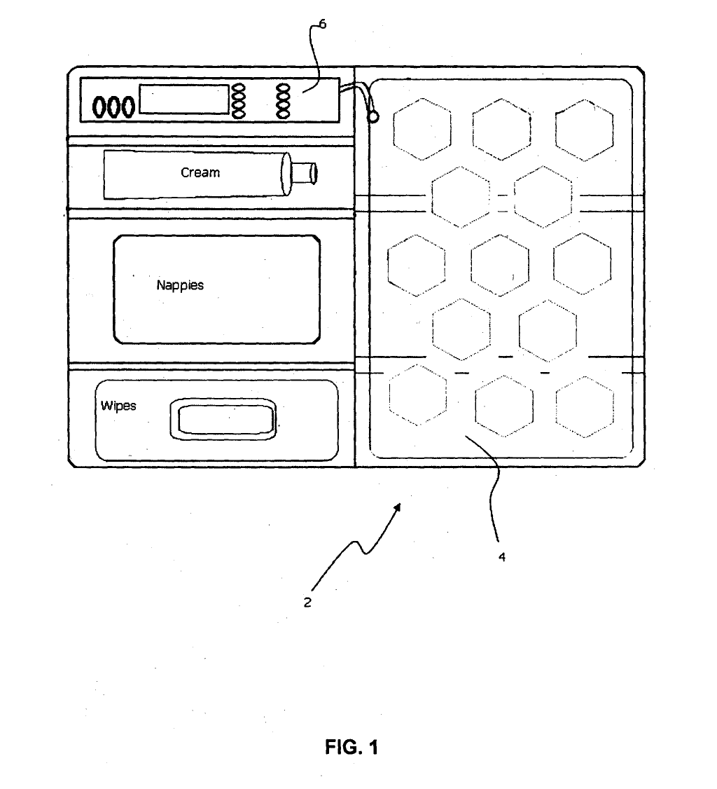

FIG. 1 is a schematic view of a first embodiment and showing a change mat in an unfolded state to expose an internal pocket for a pressure pad and internal pockets for the display and other items;

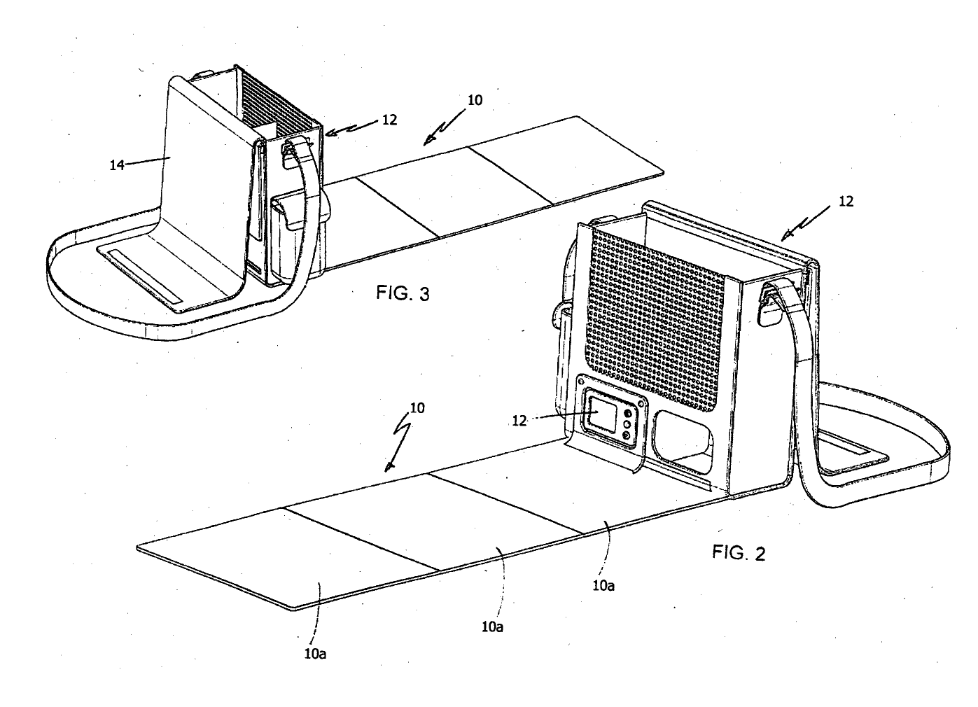

FIG. 2 is a perspective view of a second embodiment in which the change mat is integrated into a carry bag; with the change mat being shown in its unfolded operative state;

FIG. 3 is a perspective view corresponding to FIG. 2 but from the front of the bag;

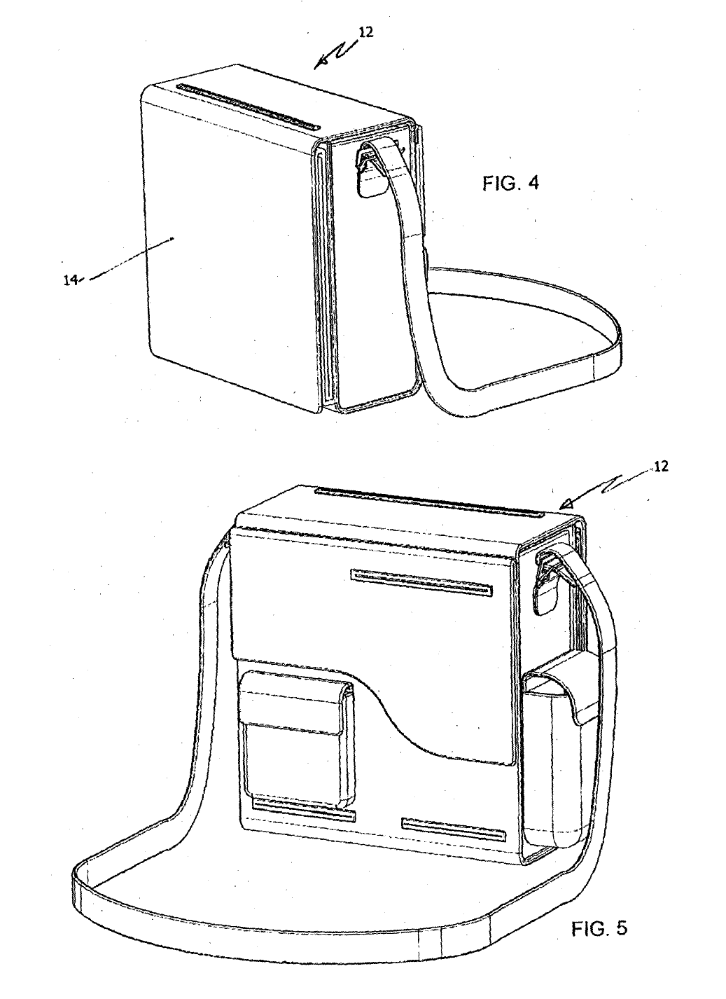

FIG. 4 is a perspective view showing the bag with the change mat folded into its storage state and enclosed within a closure flap of the bag;

FIG. 5 is a perspective view corresponding to FIG. 4 but from the front of the bag; and

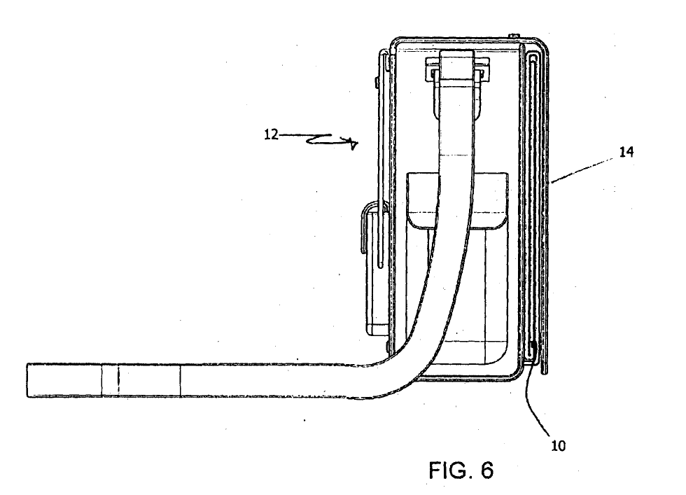

FIG. 6 is a side edge view corresponding to FIG. 4.

The system of the first embodiment of the invention comprises a thin foldable pad filled with air (or other gas), water (or other liquid) or gel. The pad is associated with an electronic weighing device having a sensor responsive to the pressure of the gas/liquid/gel under the weight of an infant lying or otherwise supported on the pad. Suitable pressure sensors for converting a pressure input into an electronic output are widely available. The principal function of the weighing device is not to provide a display of the absolute weight of the infant, although control circuitry of the device could be configured to provide that as an additional function, but, rather, to display weight gain following feeding or alternatively fluid intake following feeding (a direct correlation to weight gain) or conversely weight loss/volumetric fluid loss following vomiting. User-operated controls for the display of the weighing device can be set either to provide an output representative of weight or an output representative of volume at the choice of the user.

In this embodiment, the pressure pad is intended to be used in conjunction with a thin waterproof and washable change mat having an internal pocket into which the pad is inserted so that it is protected from soiling. The change mat itself may have padding so that it can also be used without the pressure pad which also provides a degree of padding. However, an outer cover of the pad is of an impervious waterproof material so that it can be wiped if it does become soiled. The display and the controls for the display are so configured that when the pad is within the pocket in the change mat, the display is visible to the user and the controls are readily accessible. Under normal operation when the infant is first placed on the change mat with the pad in position, the weighing device effects a datum measurement of the weight of the infant prior to feeding and when the infant is next placed on the mat either during or following feeding, the display will indicate the weight increase or volume intake according to the choice of the user. Advantageously the weighing device includes a memory function for storing the weight data and preferably the data can be downloaded to an external device such as a computer, smartphone, or USB stick for long term storage and subsequent analysis. For this purpose the weighing device includes a data output port such as a USB port.

The pressure pad is relatively thin and is foldable into a small volume for ease of storage and transportation together with the associated change mat which is also foldable into a small volume. As such, it is envisaged that the pressure pad and change mat can readily be stored in a nappy bag together with nappies, cream and baby wipes or on the tray of a pram.

FIG. 1 shows an embodiment of a change mat 2 having on one side in its unfolded state a pocket for the pressure pad 4 and on the other side a pocket for the display 6 with associated controls and pockets for cream, nappies, and wipes. For storage purposes the change mat can be folded about its longitudinal centre line from the open condition shown in the drawing to a closed condition in which the pressure pad and other contents are within the interior of the folding change mat. The pressure pad itself is also foldable whereby when the change mat is folded closed, it may, if required, be further folded transversely in the zones defined between the pockets.

It is noted that the change mat in conjunction with the pressure pad can be applied to any firm surface around the home to provide the weighing functions and also for changing the infant's nappy.

As previously mentioned, the control circuitry of the weighing device may also include functions to provide an output indicating the weight/volume loss following vomiting, or the absolute weight of the infant. In the former case, the determination of weight loss/volume loss is based on a previous weight measurement stored in the memory and the weight of the infant after vomiting. It could even be used to determine the difference in weight between a dry nappy and wet nappy so as to provide a measurement of the volume of urine expelled, and in that case the weight of a dry nappy can be stored semi-permanently in the memory following an initial action to weigh the dry nappy.

The weighing device may be battery powered or mains powered although for versatility of operation battery power is preferred preferably in conjunction with a rechargeable function for the battery.

Although as previously indicated the pressure pad can be filled with a range of different media, in a particularly preferred embodiment it is air-filled and inflated by means of a small electrically-operated pump powered by the battery, or by a small hand pump, with the pad being deflated to facilitate its storage in the folded condition. Deflation can be effected using an air valve incorporated into the structure of the pad. Moreover, having regard to the required functioning of the pad it does not have to be constructed to remain inflated for a long period of time and as a result some leakage of air through the walls of the pad can be tolerated without effecting the functionality of the pad during each period of usage. When inflation is effected using a battery-operated pump, provision can be incorporated to automatically restore the pressure of the filling if it drops below a predetermined minimum value during use.

In the embodiment shown in FIGS. 2 to 6, the mat 10 is integrated with a carry bag and comprises two or more foldable sections 10a, three sections as shown. Each section 10a contains an electronic weighing pad or load cell similar to that used in electronic kitchen scales except that the weighing pads are interconnected to provide an output representative of the cumulative weight measured by the series of weighing pads or alternatively they may input separately into the control system which then determines the cumulative weight. In the embodiment shown, the mat 10 in its unfolded operative state extends from the base of the bag 12 adjacent the rear side wall of the bag. A display 12 and associated function controls are mounted to that side wall and are clearly visible to the user in that state as is apparent in FIG. 2. In an inoperative stored condition, the sections 10a of the mat are folded so that the folded mat lies against that side wall thereby enclosing and protecting the display 12. Although the mat could be retained against that side wall by a variety of different releasable fastening systems, in the preferred embodiment this is undertaken by a flap 14 hinged to the upper edge of the opposite side of the bag and of a form that enables it to be folded over to form a closure for the open upper end of the bag with an outer part of the flap extending over the outer face of the folded mat to be releasably secured in that position. This can be achieved either by straps between the flap 14 and the body of the bag or by a releasable fastening between the lower part of the flap 14 and the lower part of the folded mat, for example a hook and loop type fastening such as that sold under the trade mark “Velcro”. The folded storage condition is shown in FIGS. 4 to 6.

The control circuitry of the weighing system will provide the different functions described in connection with the previous embodiment. Although the use of electronic weighing pads within the respective sections of the mat is particularly suitable for this embodiment as they are relatively thin and facilitate folding of the mat into its storage condition, nevertheless the mat may alternatively include a pressure pad as described in connection with the previous embodiment.

The bag itself can be stylishly configured and even although the change mat is integrated into the structure of the bag, in its storage condition folded and retained neatly against a side wall of the bag and enclosed by the upper closure flap, the bag is virtually indistinguishable from a conventional bag of that kind. In the closed storage condition of the bag as shown in FIGS. 4 to 6 the side of the bag containing the mat, and which in that condition is substantially flat and unobstructed, will constitute the inner side normally lying against the body of the user when the bag is being carried in the manner of a shoulder pack.

In a modification, the electronic weighing pads are mounted externally of the mat rather than within the mat, and are retained to the mat by a releasable fastening, for example a hook and loop type fastening such as sold under the trade mark “Velcro” to permit their removal for cleaning purposes. It is believed that as the weighing pads are exposed, this may promote greater weighing accuracy and may avoid false readings arising from someone accidentally pressing onto a weighing pad concealed within the mat itself. In this variation the pads can be detachably connected to the control circuitry including the display by a plug, or the display and control circuitry can be removable from the bag together with the pads. The mat itself may also be detachable from the bag for washing or cleaning by means of a releasable fastening such as a hook and loop type fastening such as that sold under the trade mark “Velcro”.

The embodiments have been described by way of example only and modifications are possible within the scope of the invention.

1. A fluid intake measuring system for an infant comprising a change mat for an infant, the mat containing or carrying a weighing pad responsive to the weight of an infant placed on the change mat, and a display responsive to the weighing pad to indicate weight gain or fluid volume intake of an infant placed on the mat prior to and following feeding.

2. A system according to claim 1, wherein the weighing pad is a thin foldable pad having a filling of liquid, gas or gel, and weight measurement is effected by sensing the pressure of the filling under the effect of the weight of the infant.

3. A system according to claim 1, wherein the mat contains or carries a series of two or more electronic weighing pads arranged in the length direction of the mat and interconnected whereby the display is responsive to the cumulative weight sensed by the series of pads.

4. A system according to claim 3, wherein the mat is foldable for storage by folding in one or more zones between adjacent weighing pads.

5. A system according to any claim 3 integrated into a carrying bag, wherein the mat when folded into a storage condition lies against an outer side of the bag, and the mat when in its unfolded operative state extends outwardly from a lower part of said side of the bag.

6. A system according to claim 5, wherein the said side of the bag is generally flat and the mat can be folded flat to lie against and substantially enclose that flat side.

7. A system according to claim 6, wherein the display is mounted to the said side of the bag and is enclosed by the mat in its folded storage condition and is exposed for view by the user in the unfolded operative state of the mat.

8. A carry bag comprising:
a change mat for an infant, the mat including a weighing pad responsive to the weight of an infant placed on the change mat, the mat being movable between a closed storage state where it is folded and at least a portion thereof lies against a first side of the bag, and an unfolded operative state where it is unfolded and extends outwardly from a lower part of the first side of the bag; and
a display for providing an indication of the weight of an infant placed on the mat.

9. The carry bag of claim 8, wherein the display is mounted to the first side of the bag, and wherein the display is covered by the mat when the mat is in its closed storage state and the display is exposed for view by the user when the mat is in its unfolded operative state.
